(19) United States
(12) Patent Application Publication
(10) Pub. No.: US 2023/0246161 A1
(43) Pub. Date: Aug. 3, 2023

(54) PRE-LITHIATION, PRECURSOR ELECTRODES AND METHODS OF MAKING AND USING THE SAME

(71) Applicant: GM GLOBAL TECHNOLOGY OPERATIONS LLC, Detroit, MI (US)

(72) Inventors: Qili SU, Shanghai (CN); Zhe LI, Shanghai (CN); Dewen KONG, Shanghai (CN); Mengyan HOU, Shanghai (CN); Haijing LIU, Shanghai (CN)

(73) Assignee: GM GLOBAL TECHNOLOGY OPERATIONS LLC, Detroit, MI (US)

(21) Appl. No.: 17/882,246

(22) Filed: Aug. 5, 2022

(30) Foreign Application Priority Data
Jan. 28, 2022 (CN) 202210106234.9

(51) Int. Cl. H01M 4/139; H01M 4/36; H01M 4/66; H01M 4/74; H01M 10/058; H01M 10/0525

(52) U.S. Cl. CPC H01M 4/139; H01M 4/74; H01M 4/366; H01M 4/661; H01M 10/058; H01M 10/0525; H01M 2004/027

(57) ABSTRACT

A pre-lithiated, precursor electrode includes an electroactive material layer, a current collector, and a lithium foil disposed between the electroactive material layer and the current collector. A method of preparing an electrode to be used in an electrochemical cell is provide. The method includes preparing a pre-lithiated, precursor electrode. Preparing the pre-lithiated precursor electrode includes contacting at least a first electroactive material layer with a first surface of a lithium foil assembly, where the lithium foil assembly includes a current collector and at least a first lithium foil disposed on or adjacent to a first surface of the current collector. The method may further include contacting the prelithiated, precursor electrode with an electrolyte in the electrochemical cell, where the first lithium foil at least partially or fully dissolves when contacted by the electrolyte to form the electrode and a lithium reservoir in the electrochemical cell.

### CROSS-REFERENCE TO RELATED APPLICATIONS

This application claims the benefit of Chinese Patent Application No. 202210106234.9 filed on Jan. 28, 2022. The entire disclosure of the application referenced above is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions releasing electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, a portion of the lithium ions remains with the negative electrode following the first cycle due to, for example, conversion reactions and/or the formation of a solid electrolyte interphase (“SEI”) layer on the negative electrode during the first cycle, as well as ongoing lithium loss due to, for example, continuous solid electrolyte interphase growth. Such permanent loss of lithium ions may result in a decreased specific energy and power of the battery. For example, the lithium-ion battery may experience an irreversible capacity loss of greater than or equal to about 5% to less than or equal to about 30% after the first cycle, and in the instance of silicon-containing negative electrodes (e.g., SiOₓ), or other volume-expanding negative electroactive materials (e.g., tin (Sn), aluminum (Al), germanium (Ge)), an irreversible capacity loss of greater than or equal to about 20% to less than or equal to about 40% after the first cycle.

Current methods to compensate for first cycle lithium loss include, for example, electrochemical processes where a silicon-containing anode is lithiated using an electrolyte bath, paired with lithium source such as lithium metal or lithium containing transition metal oxides. However, such processes are susceptible to air and moisture, and as a result, instability. Another method of compensation includes, for example, the deposition (e.g., spraying or extrusion or physical vapor deposition (“PVD”)) of lithium on an anode or anode material. However, in such instances, it is difficult (and costly) to produce evenly deposited lithium layers. Accordingly, it would be desirable to develop improved electrodes and electroactive materials, and methods of using the same, that can address these challenges.

### SUMMARY

This section provides a general summary of the disclosure, and is not a comprehensive disclosure of its full scope or all of its features.

The present disclosure relates to pre-lithiated, precursor electrodes, and methods of making and using the same.

In various aspects, the present disclosure provides a pre-lithiated, precursor electrode to be used in the preparation of an electrochemical cell that cycles lithium ions. The pre-lithiated, precursor electrode may include an electroactive material layer, a current collector parallel with the electroactive material layer, and a lithium foil disposed between the electroactive material layer and the current collector. The lithium foil may have a thickness greater than or equal to about 1 µm to less than or equal to about 200 µm.

In one aspect, the pre-lithiated, precursor electrode may further include an electrically conductive adhesive layer disposed between the lithium foil and the current collector. The electrically conductive adhesive layer may include one or more polymers and one or more electronic conductive fillers.

In one aspect, the pre-lithiated, precursor electrode may further include an ionically conductive adhesive layer disposed between the lithium foil and the current collector. The ionically conductive adhesive layer may include one or more polymers, one or more electronic conductive fillers, and one or more ionic conductive fillers. The ionically conductive adhesive layer may have an ionic conductivity greater than or equal to about 0.1 mS/cm to less than or equal to about 10 mS/cm.

In one aspect, the lithium foil may cover greater than or equal to about 20% to less than or equal to about 100% of a surface of the current collector. The lithium foil may have a predetermined pattern.

In one aspect, the surface of the current collector may have a sub-micro-scale surface roughening. For example, a root mean square roughness of the surface of the current collector may greater than or equal to about 0.04 µm to less than or equal to about 2 µm.

In one aspect, the current collector may be a mesh current collector. The mesh current collector may have a porosity greater than or equal to about 20% to less than or equal to about 80%.

In one aspect, the electroactive material layer may be a first electroactive material layer, the lithium foil may be a first lithium foil, and the current collector may be a copper film having a thickness greater than or equal to about 1 µm to less than or equal to about 50 µm. In such instances, the pre-lithiated, precursor electrode further includes a second electroactive material layer disposed parallel with an exposed surface of the current collector, and a second lithium foil disposed between the current collector and the second electroactive material layer.

In one aspect, the second lithium foil may cover greater than or equal to about 20% to less than or equal to about 100% of the exposed surface of the current collector. The second lithium foil may have a predetermined pattern.

In one aspect, the exposed surface of the current collector has sub-micro-scale surface roughening. For example, the exposed surface of the current collector may have a root mean square roughness greater than or equal to about 0.04 µm to less than or equal to about 2 µm.

In one aspect, the pre-lithiated, precursor electrode may further include an electrically conductive adhesive layer disposed between the second lithium foil and the current collector. The electrically conductive adhesive layer may include one or more polymers and one or more electronic conductive fillers.

In one aspect, the pre-lithiated, precursor electrode may further include an ionically conductive adhesive layer disposed between the second lithium foil and the current collector. The ionically conductive adhesive layer may include one or more polymers, one or more electronic conductive fillers, and one or more ionic conductive fillers. The ionically conductive adhesive layer may have an ionic conductivity greater than or equal to about 0.1 mS/cm to less than or equal to about 10 mS/cm.

In various aspects, the present disclosure provides a method of manufacturing a pre-lithiated, precursor electrode to be used in the preparation of an electrochemical cell that cycles lithium ions. The method may include contacting an electroactive material layer with a lithium foil assembly. The lithium foil assembly may include a current collector and a lithium foil disposed on or adjacent to a surface of the current collector. The lithium foil may have a thickness greater than or equal to about 1 µm to less than or equal to about 200 µm. The electroactive material layer contacts the lithium foil.

In one aspect, the contacting may further include a rolling process, where the electroactive material layer is dispensed from a first roll and the lithium foil assembly is disposed from a second roll, and a portion of each of the electroactive material layer and the lithium foil assembly move together between a pair of rollers that are configured to apply a pressure. The pressure may be greater than or equal to about 1 MPa to less than or equal to about 1,000 MPa.

In one aspect, the method may further include subjecting the electroactive material layer and the lithium foil assembly to hot lamination. A laminating temperature may be greater than or equal to about 50° C. to less than or equal to about 350° C. A laminating pressure may be greater than or equal to about 30 MPa to less than or equal to about 1,000 MPa.

In one aspect, the lithium foil assembly may further include an electrically conductive adhesive layer disposed between the lithium foil and the current collector. The electrically conductive adhesive layer may include one or more polymers and one or more electronic conductive fillers.

In one aspect, the lithium foil may further include an ionically conductive adhesive layer disposed between the lithium foil and the current collector. The ionically conductive adhesive layer may include one or more polymers, one or more electronic conductive fillers, and one or more ionic conductive fillers. The ionically conductive adhesive layer may have an ionic conductivity greater than or equal to about 0.1 mS/cm to less than or equal to about 10 mS/cm.

In one aspect, the lithium foil may cover greater than or equal to about 20% to less than or equal to about 100% of a surface of the current collector. The lithium foil may have a predetermined pattern.

In one aspect, the surface of the current collector may have a sub-micro-scale surface roughening. For example, a root mean square roughness of the surface of the current collector may be greater than or equal to about 0.04 µm to less than or equal to about 2 µm.

In one aspect, the current collector may be a mesh current collector. The mesh current collector may have a porosity greater than or equal to about 20% to less than or equal to about 80%.

In various aspects, the present disclosure provides a method of preparing an electrode to be used in an electrochemical cell that cycles lithium ions. The method may include preparing a pre-lithiated, precursor electrode. Preparing the pre-lithiated precursor electrode may include contacting a first electroactive material layer with a first surface of a lithium foil assembly, and contacting a second electroactive material layer with a second surface of the lithium foil assembly to form the pre-lithiated, precursor electrode, where the first surface is parallel with the second surface. The lithium foil assembly may include a current collector, a first lithium foil disposed on or adjacent to a first surface of the current collector, and a second lithium foil disposed on a second surface of the current collector. The first lithium foil may contact the first electroactive material layer. The second lithium foil may contact the second electroactive material layer. The lithium foil may have a thickness greater than or equal to about 1 µm to less than or equal to about 200 µm. The method may further include contacting the prelithiated, precursor electrode with an electrolyte in the electrochemical cell, where at least one of the first lithium foil and the second lithium foil at least partially or fully dissolves when contacted by the electrolyte to form the electrode and a lithium reservoir in the electrochemical cell.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell;

FIG. 2 is a side illustration of an example method for forming a pre-lithiated, precursor electrode in accordance with various aspects of the present disclosure;

FIG. 3A is a cross-sectional illustration of an example lithium foil assembly in accordance with various aspects of the present disclosure;

FIG. 3B is a top-down illustration of the example lithium foil assembly illustrated in FIG. 3A;

FIG. 3C is a bottom-up illustration of the example lithium foil assembly illustrated in FIG. 3A;

FIG. 4A is a cross-sectional illustration of another example lithium foil assembly in accordance with various aspects of the present disclosure;

FIG. 4B is a top-down illustration of the example lithium foil assembly illustrated in FIG. 4A;

FIG. 4C is a bottom-up illustration of the example lithium foil assembly illustrated in FIG. 4A;

FIG. 5A is a top-down illustration of another example lithium foil assembly in accordance with various aspects of the present disclosure;

FIG. 5B is a top-down illustration of another example lithium foil assembly in accordance with various aspects of the present disclosure;

FIG. 6 is a cross-sectional illustration of another example lithium foil assembly in accordance with various aspects of the present disclosure;

FIG. 7 is a cross-sectional illustration of a pre-lithiated, precursor electrode in accordance with various aspects of the present disclosure;

FIG. 8A is a graphical illustration representing electrochemical performance of an example cell prepared in accordance with various aspects of the present disclosure;

FIG. 8B is a graphical illustration representing capacity retention of an example cell prepared in accordance with various aspects of the present disclosure;

FIG. 8C is a graphical illustration representing voltage polarization between charge and discharge in cycle 10 of an example cell prepared in accordance with various aspects of the present disclosure;

FIG. 8D is a graphical illustration representing voltage polarization between charge and discharge in cycle 10 of a comparative cell; and

FIG. 8E is a graphical illustration representing the resistance of an example cell prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature’s relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

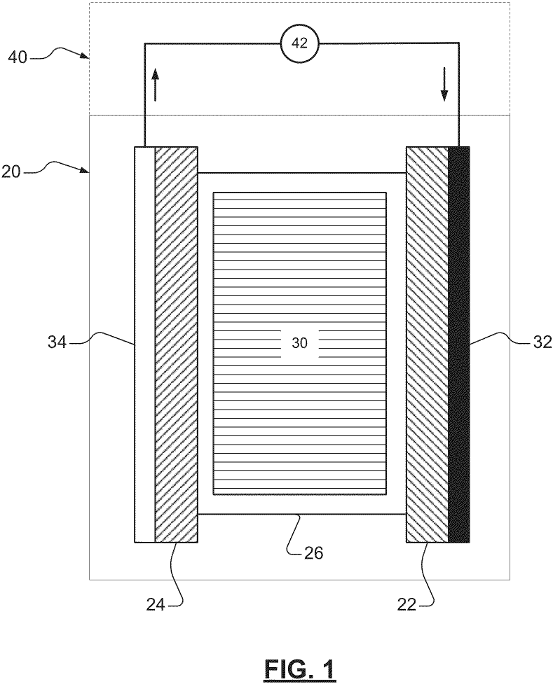

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 may be positioned at or near the negative electrode 22. For example, the first current collector 32 may be a negative electrode current collector. The first current collector 32 may be a metal foil, metal grid or screen, or expanded metal comprising copper or any other appropriate electrically conductive material known to those of skill in the art. A second current collector 34 may be positioned at or near the positive electrode 24. For example, the second current collector 34 may be a positive electrode current collector. The second current collector may be a metal foil, metal grid or screen, or expanded metal comprising aluminum or any other appropriate electrically conductive material known to those of skill in the art. The first current collector 32 and the second current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. Further, the battery 20 shown in FIG. 1 includes a liquid electrolyte 30 and shows representative concepts of battery operation. However, the current technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., > 1 M) that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCla), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic materials and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on or adjacent to one or more sides of the separator 26. The ceramic material may be selected from the group consisting of: alumina (Al₂O₃), silica (SiO₂), and combinations thereof. The heat-resistant material may be selected from the group consisting of: NOMEX®, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have a thickness greater than or equal to about 1 µm to less than or equal to about 50 µm, and in certain instances, optionally greater than or equal to about 1 µm to less than or equal to about 20 µm. The separator 26 may have a thickness greater than or equal to 1 µm to less than or equal to 50 µm, and in certain instances, optionally greater than or equal to 1 µm to less than or equal to 20 µm.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{⅔}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99} Ba_{0.005}ClO, or combinations thereof. The solid-state electrolyte particles may be nanometer sized oxide-based solid-state electrolyte particles.

The positive electrode 24 may be formed from a lithium-based active material that is capable of undergoing lithium intercalation and deintercalation, alloying and dealloying, or plating and stripping, while functioning as the positive terminal of the battery 20. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). In each instance, the positive electrode 24 may have a thickness greater than or equal to about 1 µm to less than or equal to about 500 µm, and in certain aspects, optionally greater than or equal to about 10 µm to less than or equal to about 200 µm. The positive electrode 24 may have a thickness greater than or equal to 1 µm to less than or equal to 500 µm, and in certain aspects, optionally greater than or equal to 10 µm to less than or equal to 200 µm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1 ≤ x ≤ 1) (LMO), lithium manganese nickel oxide (LiMn₍₂₋ₓ₎NiₓO₄, where 0 ≤ x ≤ 0.5) (LNMO) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0 ≤ x ≤ 1, 0 ≤ y ≤ 1, 0 ≤ z ≤ 1, and x + y + z = 1) (e.g., LiMn_{0.33}Ni_{0.33}Co_{0.33}O₂) (NMC), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄) (LFP), lithium manganese-iron phosphate (LiMn₂₋ₓFeₓPO₄, where 0 < x < 0.3) (LFMP), or lithium iron fluorophosphate (Li₂FePO₄F). In various aspects, the positive electrode 24 may comprise one or more electroactive materials selected from the group consisting of: NCM 111, NCM 532, NCM 622, NCM 811, NCMA, LFP, LMO, LFMP, LLC, and combinations thereof.

In certain variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN® black or DENKA® black), carbon fibers and nanotubes, graphene, and the like. Examples of a conductive polymer include polyaniline, polythiophene, polyacetylene, polypyrrole, and the like. In certain aspects, mixtures of the conductive materials may be used.

The positive electrode 24 may include greater than or equal to about 5 wt.% to less than or equal to about 99 wt.%, optionally greater than or equal to about 10 wt.% to less than or equal to about 99 wt.%, and in certain variations, greater than or equal to about 50 wt.% to less than or equal to about 98 wt.%, of the positive electroactive material(s); greater than or equal to 0 wt.% to less than or equal to about 40 wt.%, and in certain aspects, optionally greater than or equal to about 1 wt.% to less than or equal to about 20 wt.%, of the electronically conducting material; and greater than or equal to 0 wt.% to less than or equal to about 40 wt.%, and in certain aspects, optionally greater than or equal to about 1 wt.% to less than or equal to about 20 wt.%, of the at least one polymeric binder.

The positive electrode 24 may include greater than or equal to 5 wt.% to less than or equal to 99 wt.%, optionally greater than or equal to 10 wt.% to less than or equal to 99 wt.%, and in certain variations, greater than or equal to 50 wt.% to less than or equal to 98 wt.%, of the positive electroactive material(s); greater than or equal to 0 wt.% to less than or equal to 40 wt.%, and in certain aspects, optionally greater than or equal to 1 wt.% to less than or equal to 20 wt.%, of the electronically conducting material; and greater than or equal to 0 wt.% to less than or equal to 40 wt.%, and in certain aspects, optionally greater than or equal to 1 wt.% to less than or equal to 20 wt.%, of the at least one polymeric binder.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). In each instance, the negative electrode 22 (including the one or more layers) may have a thickness greater than or equal to about 1 µm to less than or equal to about 500 µm, and in certain aspects, optionally greater than or equal to about 10 µm to less than or equal to about 200 µm. The negative electrode 22 (including the one or more layers) may have a thickness greater than or equal to 1 µm to less than or equal to 500 µm, and in certain aspects, optionally greater than or equal to 10 µm to less than or equal to 200 µm.

In various aspects, the negative electrode 22 may be pre-lithiated. For example, the negative electrode 22 may be prepared from a pre-lithiated, precursor electrode including a lithium foil (and optionally, an electrical conductive adhesive layer), as detailed below.

The negative electroactive material may be a silicon-based electroactive material, and in further variations, the negative electroactive material may include a combination of the silicon-based electroactive material (i.e., first negative electroactive material) and one or more other negative electroactive materials. The one or more other negative electroactive materials include, for example only, carbonaceous materials (such as, graphite, hard carbon, soft carbon, and the like) and metallic active materials (such as tin, aluminum, magnesium, germanium, and alloys thereof, and the like). For example, in certain variations, the negative electroactive material may include a carbonaceous-silicon based composite including, for example, about 10 wt.% of a silicon-based electroactive material and about 90 wt.% graphite. The negative electroactive material may include a carbonaceous-silicon based composite including, for example, 10 wt.% of a silicon-based electroactive material and 90 wt.% graphite.

In certain variations, the negative electroactive material(s) in the negative electrode 22 may be optionally intermingled with one or more electrically conductive materials that provide an electron conductive path and/or at least one polymeric binder material that improves the structural integrity of the negative electrode 22. For example, the negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN® black or DENKA® black), carbon fibers and nanotubes, graphene, and the like. Examples of a conductive polymer include polyaniline, polythiophene, polyacetylene, polypyrrole, and the like. In certain aspects, mixtures of the conductive materials may be used.

The negative electrode 22 may include greater than or equal to about 5 wt.% to less than or equal to about 99 wt.%, optionally greater than or equal to about 10 wt.% to less than or equal to about 99 wt.%, and in certain variations, greater than or equal to about 50 wt.% to less than or equal to about 95 wt.%, of the negative electroactive material(s); greater than or equal to 0 wt.% to less than or equal to about 40 wt.%, and in certain aspects, optionally greater than or equal to about 1 wt.% to less than or equal to about 20 wt.%, of the electronically conducting material; and greater than or equal to 0 wt.% to less than or equal to about 40 wt.%, and in certain aspects, optionally greater than or equal to about 1 wt.% to less than or equal to about 20 wt.%, of the at least one polymeric binder.

The negative electrode 22 may include greater than or equal to 5 wt.% to less than or equal to 99 wt.%, optionally greater than or equal to 10 wt.% to less than or equal to 99 wt.%, and in certain variations, greater than or equal to 50 wt.% to less than or equal to 95 wt.%, of the negative electroactive material(s); greater than or equal to 0 wt.% to less than or equal to 40 wt.%, and in certain aspects, optionally greater than or equal to 1 wt.% to less than or equal to 20 wt.%, of the electronically conducting material; and greater than or equal to 0 wt.% to less than or equal to 40 wt.%, and in certain aspects, optionally greater than or equal to 1 wt.% to less than or equal to 20 wt.%, of the at least one polymeric binder.

As discussed above, during discharge, the negative electrode 22 may contain a comparatively high concentration of lithium, which is oxidized into lithium ions and electrons. Lithium ions may travel from the negative electrode 22 to the positive electrode 24, for example, through the ionically conductive electrolyte 30 contained within the pores of an interposed porous separator 26. Concurrently, electrons pass through an external circuit 40 from the negative electrode 22 to the positive electrode 24. Such lithium ions may be assimilated into the material of the positive electrode 22 by an electrochemical reduction reaction. The battery 20 may be recharged or regenerated after a partial or full discharge of its available capacity by an external power source, which reverses the electrochemical reactions that transpired during discharge.

In certain instances, however, especially in instances of silicon-containing electroactive materials, a portion of the intercalated lithium often remains with the negative electrode 22. For example, as a result of conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) breakage and rebuild. The solid electrolyte interface (SEI) layer can form over the surface of the negative electrode 22, which is often generated by electrolyte decomposition, which consumes, irreversibility, lithium ions. Such permanent loss of lithium ions may result in a decreased specific energy and power in the battery 20. For example, the battery 20 may experience an irreversible capacity loss of greater than or equal to about 5% to less than or equal to about 40% after the first cycle.

Lithiation, for example pre-lithiation of the electroactive materials prior to incorporation into the battery 20, may compensate for such lithium losses during cycling. For example, an amount of lithium pre-lithiated together with appropriate negative electrode capacity and/or positive electrode capacity ratio (N/P ratio) can be used to control electrochemical potential within an appropriate window so as to improve the cycle stability of the battery 20. Pre-lithiation can drive down the potential for silicon-containing electrodes. By way of non-limiting example, lithiation of silicon by direct reaction can be expressed by: 4.4xLi + Si → Li_{4.4x}Si, where 0 ≤ x ≤ 1, while for electrochemical lithiation of silicon, it can be expressed as 4.4xLi⁺ + 4.4xe⁻⁺ Si → Li_{4.4x}Si. In each instance, the reserved lithium can compensate for lithium lost during cycling, including during the first cycle, so as to decrease capacity loss over time.

Common lithiation methods, including electrochemical, direct contact, and lamination methods, are challenging because of the adhesiveness and brittleness (e.g., wrinkling) of lithium foil. In various aspects, the present disclosure provides methods for forming pre-lithiated, precursor electrodes that may form, for example, electrode 22, 24 such as illustrated in FIG. 1. Pre-lithiated, precursor electrodes are electrodes that have not yet been contacted with an electrolyte and not yet cycled in an electrochemical cell, where electrodes (like electrodes 22, 24 illustrated in FIG. 1) are electrodes that have been exposed to electrolyte or ions and cycled in the electrochemical cell. In the present instance, as further detailed below, pre-lithiated, precursor electrodes include a current collector, at least one electroactive material layer, and a lithium foil layer disposed between the current collector and the at least one electroactive material layer. The lithium foil layer at least partially or fully dissolves when contacted with an electrolyte and cycled in an electrochemical cell. The remaining at least one electroactive material layer and current collector define the electrode (e.g., such as electrode 22 and/or electrode 24 illustrated in FIG. 1).

Methods for forming pre-lithiated, precursor electrodes, in accordance with various aspects of the present disclosure, generally include integrating a lithium foil between an electrode or electroactive material film (e.g., a negative electrode or anode film) and a current collector (e.g., a negative electrode current collector). As mentioned, upon contact with an electrolyte (like the electrolyte 30 illustrated in FIG. 1), for example, after electrolyte filling in a battery fabrication process, where the lithium foil layer, the electroactive material film layer, and the electrolyte form a Voltaic cell, the lithium foil at least partially or fully dissolves in the electrolyte. As the lithium foil dissolves in the electrolyte, the lithium foil releases lithium ions (Li⁺) into the electrolyte and releases electrons into the electroactive layer. In such instances, the electroactive material layer, including the extra electrons, will react with lithium ions in electrolyte to form a lithium reservoir in a cell (like the battery 20 illustrated in FIG. 1).

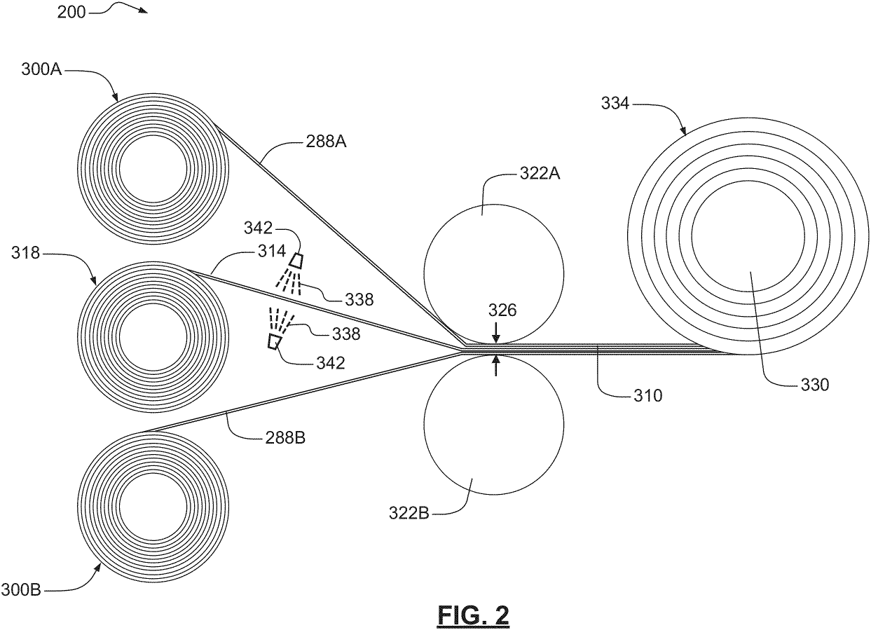

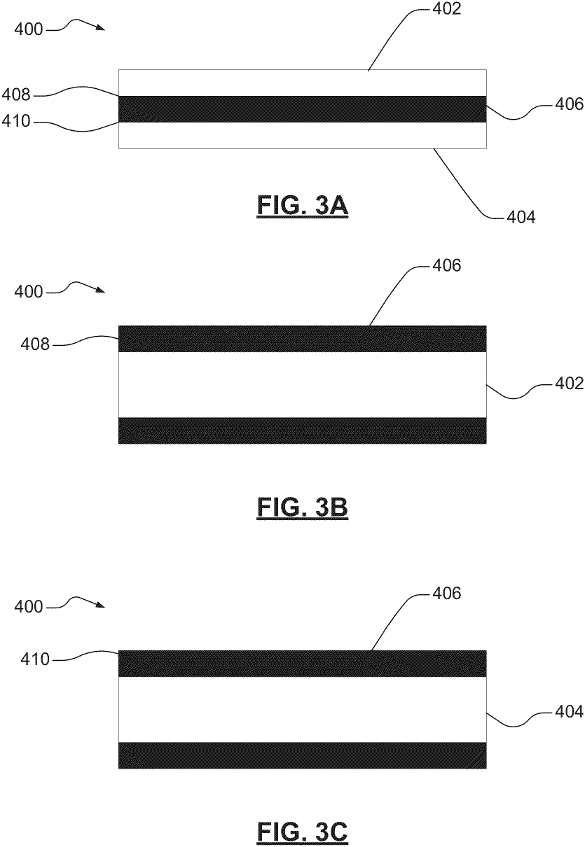

An example method 200 for preparing a pre-lithiated, precursor electrode is illustrated in FIG. 2. As illustrated, the method 200 may be a lamination process, where a lithium foil assembly 314 (including a current collector and one or more lithium foils disposed thereon (and optionally, an electric conductive adhesive layer), for example, as illustrated in FIGS. 3A-3C, 4A-4C, 5A-5B, and 6) is provided on a lithium composite roll 318, and two electroactive material films 288A, 288B in the form of electrode film rolls 300A, 300B are provided so to form a double-sided electrode assembly 310, when the lithium foil assembly 314 and the two electroactive material films 288A, 288B are pressed between a pair of rollers 322A, 322B having a lamination gap 326 therebetween. The lamination gap 326 may be defined in a direction transverse to the lithium foil assembly 314 and electrode films 288A, 288B.

The rollers 322A, 322B may be configured to apply a high calendaring pressure (e.g., greater than or equal to about 1 MPa to less than or equal to about 1,000 MPa, and in certain aspects, optionally greater than or equal to 1 MPa to less than or equal to 1,000 MPa) as the lamination layers (e.g., the lithium foil assembly 314 and the electrode films 288A, 288B) move through the lamination gap 326. For example, in certain variations, the lamination gap 326 is a sum of thicknesses of the lithium foil assembly 314 and the two electrode films 288A, 288B. In other variations, the lamination gap 326 may be smaller than the sum of thicknesses to achieve a desired electrode press density. For example, it may be desirable for the pre-lithiated, precursor electrode to have a press density greater than or equal to about 1.5 g/cm³ to less than or equal to about 5.0 g/cm³, and in certain aspects, optionally density greater than or equal to 1.5 g/cm³ to less than or equal to 5.0 g/cm³. In each variation, however, the illustrated calendaring process (i.e., pressing between the pair of rollers 322A,322B) is a direct process of free-standing films. That is, the illustrated method 200 ensures adhesion between the different lamination layers (e.g., the lithium foil assembly 314 and the electrode films 288A, 288B), while reducing the number of necessary fabrications processes during cell formation.

The lithium foil assembly 314 may have a variety of configurations. However, in each variation, the lithium foil assembly 314 includes a current collector and one or more lithium foils covering at least a portion of one or more surfaces of the current collector. For example, FIG. 3A is a cross-sectional illustration of an example lithium foil assembly 400. As illustrated, the lithium foil assembly 400 includes a first lithium foil 402, a second lithium foil 404, and a current collector 406 disposed therebetween. For example, the first lithium foil 402 may be disposed on or adjacent toa first surface 408 of the current collector 406, and the second lithium foil 404 may be disposed one or adjacent to a second surface 410 of the current collector 406. The first surface 408 of the current collector 406 may be substantially parallel with the second surface 410 of the current collector 406.

As illustrated in FIG. 3B (a top-down view of the lithium foil assembly 400), the first lithium foil 402 may cover greater than or equal to about 20% to less than or equal to about 100%, and in certain aspects, optionally greater than or equal to 20% to less than or equal to 100%, of a total exposed area of the first surface 408 of the current collector 406. As illustrated in FIG. 3C (a bottom-up view of the lithium foil assembly 400), the second lithium foil 404 may cover greater than or equal to about 20 % to less than or equal to about 100%, and in certain aspects, optionally greater than or equal to 20% to less than or equal to 100%, of a total exposed area of the second surface of the current collector 406.

Although not illustrated, in certain variations, the first and/or second surfaces 408, 410 may be roughened so as to increase adhesion between the current collector and an electroactive material layer during subsequent lamination (such as illustrated in FIG. 2). The first and/or second surfaces 408, 410 may be roughen using various processes, including for example only, chemical etching, pitting corrosion, carbon coating, pulse laser ablation, and the like. For example, the first and/or second surfaces 408, 410 may each have sub-micro-scale surface roughening and a square roughness greater than or equal to about 0.4 µm to less than or equal to about 2 µm, and in certain aspects, optionally greater than or equal to 0.4 µm to less than or equal to 2 µm.

In each variation, the first and second lithium foils 402, 404 may each have thicknesses greater than or equal to about 1 µm to less than or equal to about 200 µm, and in certain aspects, optionally greater than or equal to about 5 µm to less than or equal to about 50 µm. The first and second lithium foils 402, 404 may each have thicknesses greater than or equal to 1 µm to less than or equal to 200 µm, and in certain aspects, optionally greater than or equal to 5 µm to less than or equal to 50 µm. The thicknesses of the first and second lithium foils 402, 404 may be the same or different.

In certain variations, the current collector 406 may be a copper film. In other variations, the current collector 406 may be a stainless-steel foil. In still other variations, the current collector 406 may be a nickel foil. In each variation, the current collector 406 may have a thickness greater than or equal to about 1 µm to less than or equal to about 50 µm, and in certain aspects, optionally greater than or equal to about 5 µm to less than or equal to about 20 µm. The current collector 406 may have a thickness greater than or equal to 1 µm to less than or equal to 50 µm, and in certain aspects, optionally greater than or equal to 5 µm to less than or equal to 20 µm.

The lithium foil assembly 400 may have an overall thickness of greater than or equal to about 1 µm to less than or equal to about 300 µm. The lithium foil assembly 400 may have an overall thickness of greater than or equal to 1 µm to less than or equal to 300 µm. In certain variations, the lithium foil assembly 400 may be prepared by cold rolling the first lithium foil 402, the current collector 406, and the second lithium foil 404 in a dry room. In other variations, the lithium foil assembly 400 may be prepared by electro-depositing lithium on one or more sides of the current collector 406 to form the first lithium foil 402 and/or the second lithium foil 406. In still further variations, the lithium foil assembly 400 may be prepared by lithium melt casting onto one or more sides of the current collector 406 to form the first lithium foil 402 and/or the second lithium foil 406.

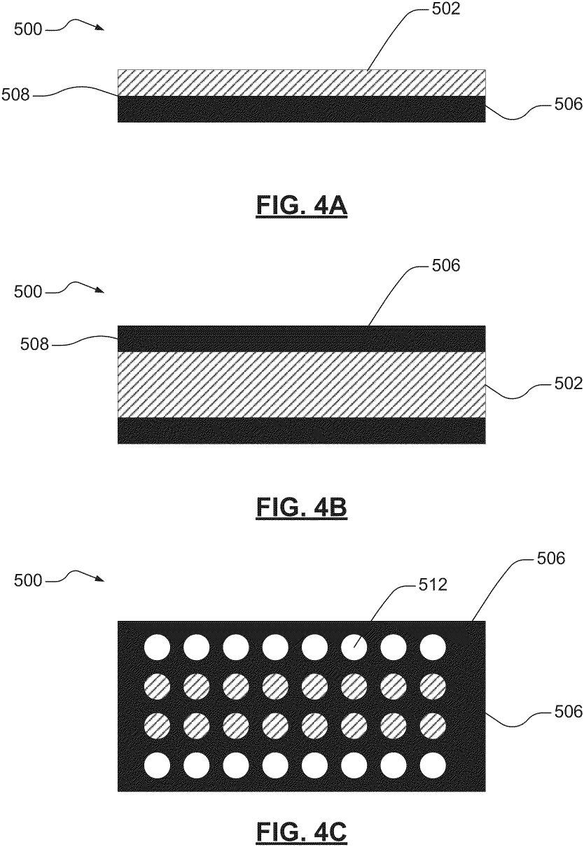

FIG. 4A is a cross-sectional illustration of another example lithium foil assembly 500. As illustrated, the lithium foil assembly 500 includes a lithium foil 502 disposed on or adjacent to a first surface of 508 of a current collector 506. As illustrated in FIG. 4B (a top-down view of the lithium foil assembly 500), the lithium foil 502 may cover greater than or equal to about 20% to less than or equal to about 100%, and in certain aspects, optionally greater than or equal to 20% to less than or equal to 100% of a total exposed area of the first surface 508 of the current collector 506. The lithium foil 502 may have a thickness greater than or equal to about 1 µm to less than or equal to about 200 µm, and in certain aspects, optionally greater than or equal to about 5 µm to less than or equal to about 50 µm. The lithium foil 502 may have a thickness greater than or equal to 1 µm to less than or equal to 200 µm, and in certain aspects, optionally greater than or equal to 5 µm to less than or equal to 50 µm.

As illustrated in FIG. 4C (a bottom-up view of the lithium foil assembly 500), the current collector 506 may be a mesh current collector (e.g., a mesh copper) having a plurality of pores or openings 512. For example, the current collector 506 may have a porosity greater than or equal to about 20% to less than or equal to about 80%, and in certain aspects, optionally greater than or equal to about 20% to less than or equal to about 80%. Via the pores 512 the lithium foil 502 may lithiated both the first electroactive material film 228A and the second electroactive material film 228B

As illustrated, the lithium foil 502 fills or covers only a portion of the total number of pores or openings 512. The current collector 506 may have a thickness greater than or equal to about 1 µm to less than or equal to about 50 µm, and in certain aspects, optionally greater than or equal to about 5 µm to less than or equal to about 20 µm. The current collector 506 may have a thickness greater than or equal to 1 µm to less than or equal to 50 µm, and in certain aspects, optionally greater than or equal to 5 µm to less than or equal to 20 µm.

The lithium foil assembly 500 may have an overall thickness of greater than or equal to about 1 µm to less than or equal to about 300 µm. The lithium foil assembly 500 may have an overall thickness of greater than or equal to 1 µm to less than or equal to 300 µm. In certain variations, the lithium foil assembly 500 may be prepared by cold rolling the lithium foil 502 and the current collector 506 in a dry room. In other variations, the lithium foil assembly 500 may be prepared by electro-depositing lithium on one or more sides of the current collector 506 to form the lithium foil 502. In still further variations, the lithium foil assembly 500 may be prepared by lithium melt casting onto one or more sides of the current collector 506 to form the lithium foil 502.

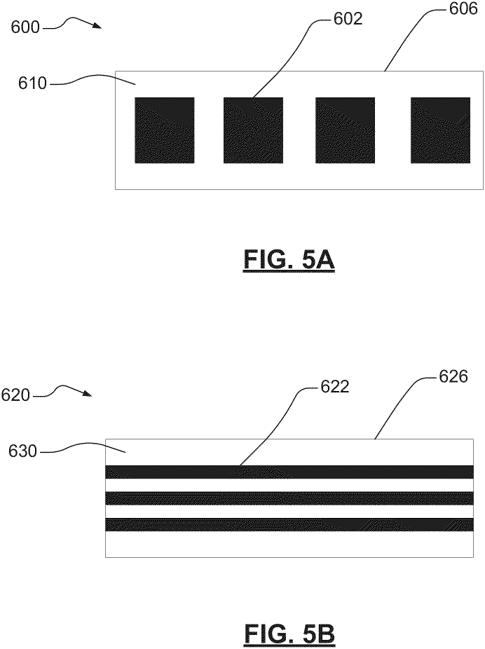

In various aspects, lithium foil assemblies may include lithium foils disposed on or adjacent to one or more surfaces of a current collector in a manner so as to form a predetermined pattern. For example, FIG. 5A is a top-down view of an example lithium foil assembly 600, where a lithium foil 602 is disposed on or adjacent to a surface 610 of a current collector 606 to form an intermittent pattern; and FIG. 5B is a top-down view of another example lithium foil assembly 620, where a lithium foil 622 is disposed on or adjacent to a surface 630 of a current collector 626 so as to form a stripe pattern. The skilled artisan will appreciate that various other patterns and configurations could be similarly selected.

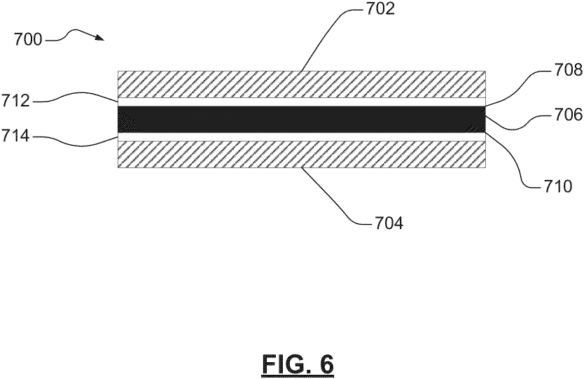

In various aspects, lithium foil assemblies may include one or more electric conductive adhesive layers. For example, FIG. 6 is a cross-sectional illustration of another example lithium foil assembly 700, including a first electrically conductive adhesive layer 712 disposed between a first lithium foil 702 and a first surface 708 of a current collector 706, and a second electrically conductive adhesive layer 714 disposed between a second lithium foil 704 and a second surface 710 of the current collector 706.

The first electrically conductive adhesive layer may cover greater than or equal to about 50% to less than or equal to about 100%, and in certain aspects, optionally greater than or equal to 50% to less than or equal to 100%, of a total exposed area of the first surface 708 of the current collector 706, and the second electrically conductive adhesive layer may cover greater than or equal to about 50% to less than or equal to about 100%, and in certain aspects, optionally greater than or equal to 50% to less than or equal to 100%, of a total exposed area of the second surface 710 of the current collector 706.

The first lithium foil 702 may cover greater than or equal to about 20% to less than or equal to about 100%, and in certain aspects, optionally greater than or equal to 20% to less than or equal to 100% of a total exposed area of the first electrically conductive adhesive layer 712. The second lithium foil 704 may cover greater than or equal to about 20% to less than or equal to about 100%, and in certain aspects, optionally greater than or equal to 20% to less than or equal to 100% of a total exposed area of the second electrically conductive adhesive layer 714. Although not illustrated, in certain variations, the first and second lithium foils 702, 704 may be patterned, for example, as illustrated in FIGS. 5A-5B.

The first and second electrically conductive adhesive layers 712, 714 may each have thicknesses greater than or equal to about 0.1 µm to less than or equal to about 10 µm, and in certain aspects, optionally greater than or equal to about 1 µm to less than or equal to about 5 µm. The first and second electrically conductive adhesive layers 712, 714 may each have thicknesses greater than or equal to 0.1 µm to less than or equal to 10 µm, and in certain aspects, optionally greater than or equal to 1 µm to less than or equal to 5 µm. The thicknesses of the first and second electrically conductive adhesive layers 712, 714 may be the same or different.

The first and second lithium foils 702, 704 may each have thicknesses greater than or equal to about 1 µm to less than or equal to about 200 µm, and in certain aspects, optionally greater than or equal to about 5 µm to less than or equal to about 50 µm. The first and second lithium foils 702, 704 may each have thicknesses greater than or equal to 1 µm to less than or equal to 200 µm, and in certain aspects, optionally greater than or equal to 5 µm to less than or equal to 50 µm. The thicknesses of the first and second lithium foils 702, 704 may be the same or different.

The lithium foil assembly 700 may have an overall thickness of greater than or equal to about 1 µm to less than or equal to about 300 µm. The lithium foil assembly 700 may have an overall thickness of greater than or equal to 1 µm to less than or equal to 300 µm. In certain variations, the lithium foil assembly 700 may be prepared by cold rolling the first lithium foil 702, the first electrically conductive adhesive layer 712, the current collector 706, the second electrically conductive adhesive layer 714, and the second lithium foil 704 in a dry room. In other variations, the lithium foil assembly 700 may be prepared by electro-depositing lithium and/or the electrically conductive adhesive on one or more sides of the current collector 706 to form the first lithium foil 702 and/or the first electrically conductive adhesive layer 712 and/or the second lithium foil 706 and/or the second electrically conductive adhesive layer 714. In still further variations, the lithium foil assembly 700 may be prepared by lithium melt casting onto one or more sides of the current collector 706 to form the first lithium foil 702 and/or the second lithium foil 706, where the current collector 706 is coted with the first electrically conductive adhesive layer 712 and/or the second electrically conductive adhesive layer 714

In various aspects, the first and second electrically conductive adhesive layers 712, 714 include greater than or equal to about 0.1 wt.% to less than or equal to about 50 wt.%, and in certain aspects, optionally greater than or equal to 0.1 wt.% to less than or equal to 50 wt.%, of a polymer, and greater than or equal to about 50 wt.% to less than or equal to about 99.1 wt.%, and in certain aspects, greater than or equal to 50 wt.% to less than or equal to 99.1 wt.%, of an electronic conductive filler.

In certain variations, the polymer may be a polymer that readily resists solvents, while providing good adhesion. For example, the polymer may include epoxy, polyimide (polemic acid), polyester, vinyl ester, vinyl ester, and the like. In other variations, the polymer may include less solvent-resistant polymers, such as thermoplastic polymers, including for example only, polyvinylidene fluoride (PVDF), polyamide, silicone, acrylic, and the like. In each variation, the electronic conductive filler may include carbon materials, like super P, carbon black, graphene, carbon nanotubes, carbon nanofibers, metal powders (e.g., silver, aluminum, nickel, and the like)., and the like.

In certain variations, one or both of the first and second electrically conductive adhesive layers 712, 714 may further include an ionic conductive filler, such that the first electrically conductive layer 712 and/or the second electrically conductive layer 714 has an ionic conductivity greater than or equal to about 0.1 mS/cm to less than or equal to about 10 mS/cm, and in certain aspects, optionally greater than or equal to 0.1 mS/cm to less than or equal to 10 mS/cm.

The first electrically conductive layer 712 and/or the second electrically conductive layer 714 may include greater than or equal to about 5 wt.% to less than or equal to about 30 wt.%, and in certain aspects, optionally greater than or equal to 5 wt.% to less than or equal to 30 wt.%, of an ionic conductive filler. The ionic conductive filler includes, for example, lithium ion fast conductive materials, such as Li_{1.3}Al_{0.3}Ti_{1.7}(PO₄)₃ (LATP), Li₇La₃Zr₂O₁₂ (LLZO), Li₁₊ₓAlₓGe₂₋ₓ(PO₄)₃ (where 0 ≤ x ≤ 2) (LAGP), and the like.

With renewed reference to FIG. 2, in various aspects, as illustrated, the electrode films 288A, 288B may be adhered to the lithium foil assembly 314 using an electrically-conductive glue 338 that can be applied to one or more sides (e.g., a first side substantially parallel with a second side) of the lithium foil assembly 314 by one or more nozzles 342 disposed upstream of the rollers 322A, 322B. In other variations, the electrically-conductive glue 388 may instead be applied to one or more surfaces of each electrode films 288A, 288B. In still other variations, the electrically-conductive glue 388 may be applied to both (i) one or more sides of the lithium foil assembly 314 and (ii) one or more surfaces of each electrode films 288A, 288B.

In each variation, the conductive glue 338 includes a polymer and conductive component. The polymer may be generally resistant to solvents, while providing good adhesion. For example, the polymers may include epoxy, polyimide, poly(acrylic acid) (PAA), polyester, vinyl ester, thermoplastic polymers (e.g., polyvinylidene fluoride (PVDF), polyamide, silicone, and/or acrylic), and combinations thereof. The conductive component may include carbon materials (e.g., carbon black, graphene, carbon nanotubes, carbon nanofiber, and the like) and/or metal powder (e.g., silver, aluminum, nickel, and the like). A weight ratio of the polymer to conductive component in the conductive glue 338 may be greater than or equal to about 0.1% to less than or equal to about 50%.

In various aspects, after passing through the lamination gap 326, the electrode assembly 310 may be wound onto to a core 330 to form an electrode assembly roll 334. Although not illustrated, the skilled artisan will appreciate that in various aspects the method 200 may further include one or more additional processing steps. For example, in certain variations, the electrode assembly 310 may be notched prior to being wound onto the core 330. In still other variations, the one or more separators may be disposed on or adjacent to one or more surfaces of the electrode assembly 310 prior to being wound onto the core 330.

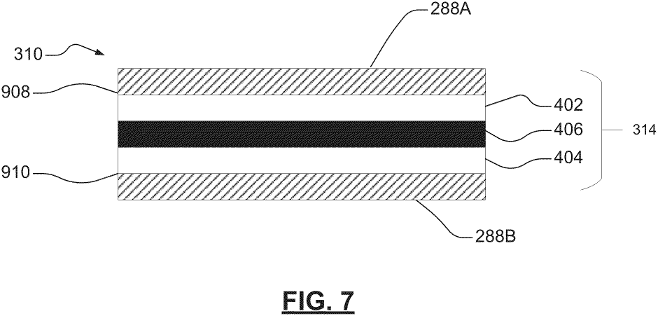

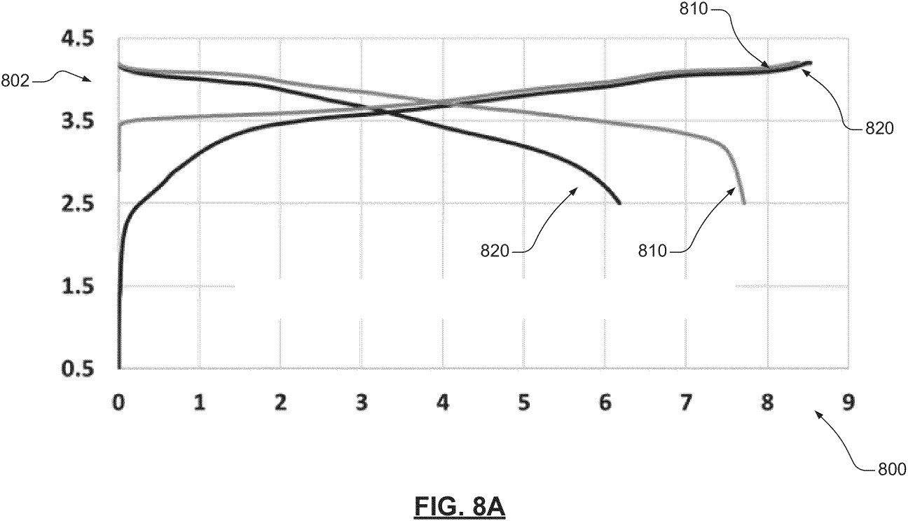

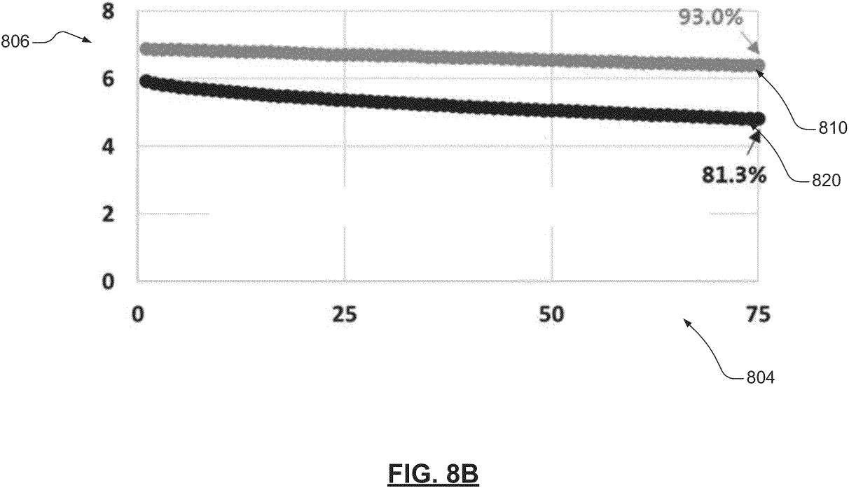

FIG. 7 is a cross-sectional illustration of the double-sided pre-lithiated, precursor electrode assembly 310 prepared, for example, using the method 200 illustrated in FIG. 2 and the lithium foil assembly 400 illustrated in FIG. 3 as the lithium foil assembly 314. As illustrated in FIG. 7, the double-sided electrode assembly 310 includes, in layer order, the first electroactive material film 288A, the first lithium foil 402, the current collector 406, the second lithium foil 404, and the second electroactive material film 288B. For example, the first electroactive material film 228A may be disposed on or adjacent to an exposed surface 908 of the first lithium foil 402, and the second electroactive material film 228B may be disposed on or adjacent to an exposed surface 910 of the second lithium foil 402. The placement of the lithium foils 402, 404 (i.e., cover the lithium foils 402, 404 with the electroactive material films 228A, 228B) protects the lithium foils 402, 404, for example, from wrinkling, during subsequent processing. The double-sided electrode assembly 310 may have an overall thickness of greater than or equal to about 1 µm to less than or equal to about 300 µm, and in certain aspects, optionally greater than or equal to about 5 µm to less than or equal to about 100 µm. The double-sided electrode assembly 310 may have an overall thickness of greater than or equal to 1 µm to less than or equal to 300 µm, and in certain aspects, optionally greater than or equal to 5 µm to less than or equal to 100 µm.

Pre-lithiated, precursor electrodes-like the pre-lithiated, precursor electrode 310 illustrated in FIG. 7—are incorporated within an electrochemical cell— like the battery 20 illustrated in FIG. 1—and upon contact with an electrolyte (like the electrolyte 30 illustrated in FIG. 1), for example, after electrolyte filling in a battery fabrication process, where the lithium foil layer, the electroactive material film layer, and the electrolyte form a Voltaic cell, the lithium foil dissolves in the electrolyte. As the lithium foil dissolves in the electrolyte, the lithium foil releases lithium ions (Li⁺) into the electrolyte and releases electrons into the electroactive layer. In such instances, the electroactive material layer, including the extra electrons, will react with lithium ions in electrolyte to form a lithium reservoir in a cell (like the battery 20 illustrated in FIG. 1).

After the pre-lithiated, precursor electrode is incorporated into a cell, and consumption of the lithium foil, a hot lamination process (e.g., laminating machine, like a roller press and/or platens) may be employed to form a compact pouch cell. In various aspects, the laminating temperature is greater than the glass transition temperature, and lower than the melting point, of the polymer glue. For example, the laminating temperature may be greater than or equal to about 50° C. to less than or equal to about 350° C., and in certain aspects, optionally greater than or equal to about 80° C. to less than or equal to about 120° C. The laminating temperature may be greater than or equal to 50° C. to less than or equal to 350° C., and in certain aspects, optionally greater than or equal to 80° C. to less than or equal to 120° C. The laminating pressure may be greater than or equal to about 30 MPa to less than or equal to about 1,000 MPa, and in certain aspects, optionally greater than or equal to about 50 MPa to less than or equal to about 100 MPa. The laminating pressure may be greater than or equal to 30 MPa to less than or equal to 1,000 MPa, and in certain aspects, optionally greater than or equal to 50 MPa to less than or equal to 100 MPa.

Certain features of the current technology are further illustrated in the following non-limiting examples.

### EXAMPLE

Example battery cells may be prepared in accordance with various aspects of the present disclosure. For example, an example cell 810 may include a pre-lithiated negative electrode prepared using a pre-lithiated, precursor electrode, like the pre-lithiated, precursor electrode 400 illustrated in FIGS. 3A-3C, the pre-lithiated, precursor electrode 500 illustrated FIGS. 4A-4C, the pre-lithiated, precursor electrode 600 illustrated in FIGS. 5A-5B, and/or the pre-lithiated, precursor electrode 700 illustrated in FIG. 6. The example cell 810 may further include a separator and a positive electrode, which includes LiNi_{0.94}Mn_{0.06}O₂ as the positive electroactive material. A comparative cell 820 may include a negative electrode that is not pre-lithiated, a separator, and a positive electrode, which includes LiNi_{0.94}Mn_{0.06}O₂ as the positive electroactive material.

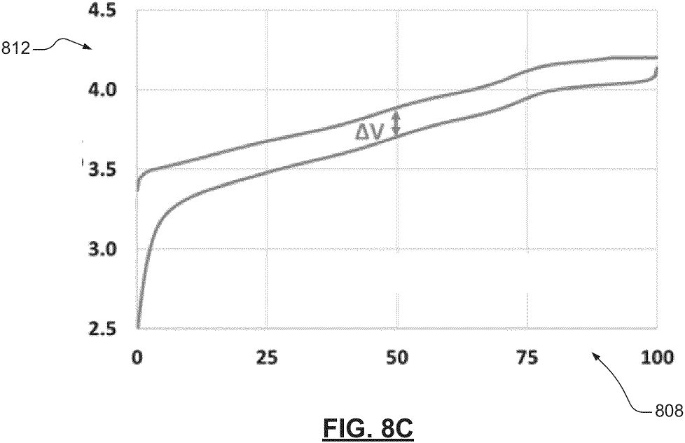

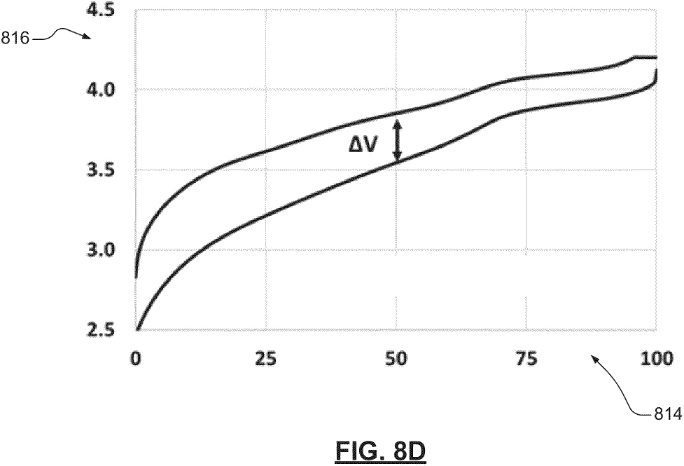

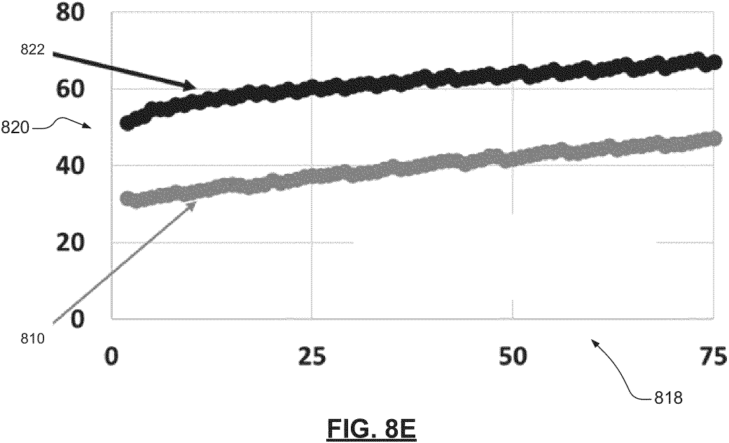

FIG. 8A is a graphical illustration representing electrochemical performance of the example cell 810 as compared to the comparative cell 820, where the x-axis 800 represents capacity (mAh), and the y-axis 802 represents voltage (V). As illustrated, the example battery cell 810, including a pre-lithiated electrode, prepared in accordance with various aspects of the present disclosure, has improved performance and capacity.

FIG. 8B is a graphical illustration representing capacity retention of the example cell 810 as compared to the comparative cell 820, where the x-axis 804 represents cycle number, and the y-axis 806 represents capacity (mAh). As illustrated, the example battery cell 810, including a pre-lithiated electrode, prepared in accordance with various aspects of the present disclosure, has improved capacity retention.

FIG. 8C is a graphical illustration representing voltage polarization between charge and discharge in cycle 10 of the example cell 810, where the x-axis 808 represents state of charge (SOC), and the y-axis 812 represents voltage (V). FIG. 8D is a graphical illustration representing voltage polarization between charge and discharge in cycle 10 of the comparative cell 820 where the x-axis 814 represents state or charge (SOC), and the y-axis 816 represents voltage (V). As illustrated, the example battery cell 810, including the pre-lithiated electrode prepared in accordance with various aspects of the present disclosure, has lower voltage polarization.

FIG. 8E is a graphical illustration representing the cell resistance at 50 % state of charge (SOC) of the example cell 810 as compared to the comparative cell 820, where the x-axis 818 represents cycle number, and the y-axis 822 represents resistance (ohms). As illustrated, there is no significant increase in resistance in the example cell 810 as a result of the lithium foil pre-lithiation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pre-lithiated, precursor electrode to be used in the preparation of an electrochemical cell that cycles lithium ions, the pre-lithiated, precursor electrode comprising:
an electroactive material layer,
a current collector parallel with the electroactive material layer, and
a lithium foil disposed between the electroactive material layer and the current collector, wherein the lithium foil has a thickness greater than or equal to about 1 µm to less than or equal to about 200 µm.

2. The pre-lithiated, precursor electrode of claim 1, further comprising:
an electrically conductive adhesive layer disposed between the lithium foil and the current collector, wherein the electrically conductive adhesive layer comprises one or more polymers and one or more electronic conductive fillers.

3. The pre-lithiated, precursor electrode of claim 1, further comprising:
an ionically conductive adhesive layer disposed between the lithium foil and the current collector, wherein the ionically conductive adhesive layer comprises one or more polymers, one or more electronic conductive fillers, and one or more ionic conductive fillers, and has an ionic conductivity greater than or equal to about 0.1 mS/cm to less than or equal to about 10 mS/cm.

4. The pre-lithiated, precursor electrode of claim 1, wherein the lithium foil covers greater than or equal to about 20% to less than or equal to about 100% of a surface of the current collector, and wherein the lithium foil has a predetermined pattern.

5. The pre-lithiated, precursor electrode of claim 4, wherein the surface of the current collector has sub-micro-scale surface roughening and a root mean square roughness greater than or equal to about 0.04 µm to less than or equal to about 2 µm.

6. The pre-lithiated, precursor electrode of claim 1, wherein the current collector is a mesh current collector having a porosity greater than or equal to about 20 % to less than or equal to about 80%.

7. The pre-lithiated, precursor electrode of claim 1, wherein the electroactive material layer is a first electroactive material layer, and the lithium foil is a first lithium foil, and
wherein the current collector is a copper film having a thickness greater than or equal to about 1 µm to less than or equal to about 50 µm, and the pre-lithiated, precursor electrode further comprises:
a second electroactive material layer disposed parallel with an exposed surface of the current collector; and
a second lithium foil disposed between the current collector and the second electroactive material layer.

8. The pre-lithiated, precursor electrode of claim 7, wherein the second lithium foil covers greater than or equal to about 20% to less than or equal to about 100 % of the exposed surface of the current collector, and wherein the second lithium foil has a predetermined pattern.

9. The pre-lithiated, precursor electrode of claim 7, wherein the exposed surface of the current collector has sub-micro-scale surface roughening and a root mean square roughness greater than or equal to about 0.04 µm to less than or equal to about 2 µm.

10. The pre-lithiated, precursor electrode of claim 7, further comprising:
an electrically conductive adhesive layer disposed between the second lithium foil and the current collector, wherein the electrically conductive adhesive layer comprises one or more polymers and one or more electronic conductive fillers.

11. The pre-lithiated, precursor electrode of claim 7, further comprising:
an ionically conductive adhesive layer disposed between the second lithium foil and the current collector, wherein the ionically conductive adhesive layer comprises one or more polymers, one or more electronic conductive fillers, and one or more ionic conductive fillers, and has an ionic conductivity greater than or equal to about 0.1 mS/cm to less than or equal to about 10 mS/cm.

12. A method of manufacturing a pre-lithiated, precursor electrode to be used in the preparation of an electrochemical cell that cycles lithium ions, the method comprising:
contacting an electroactive material layer with a lithium foil assembly, wherein the lithium foil assembly comprises:
a current collector, and
a lithium foil disposed on or adj acent to a surface of the current collector, wherein the lithium foil has a thickness greater than or equal to about 1 µm to less than or equal to about 200 µm and the electroactive material layer contacts the lithium foil.

13. The method of claim 12, wherein the contacting further comprises a rolling process, wherein the electroactive material layer is dispensed from a first roll and the lithium foil assembly is disposed from a second roll, and a portion of each of the electroactive material layer and the lithium foil assembly move together between a pair of rollers that are configured to apply a pressure greater than or equal to about 1 MPa to less than or equal to about 1,000 MPa.

14. The method of claim 13, further comprising:
subjecting the electroactive material layer and the lithium foil assembly to hot lamination, wherein a laminating temperature is greater than or equal to about 50° C. to less than or equal to about 350° C. and a laminating pressure is greater than or equal to about 30 MPa to less than or equal to about 1,000 MPa.

15. The method of claim 12, wherein the lithium foil assembly further comprises:
an electrically conductive adhesive layer disposed between the lithium foil and the current collector, wherein the electrically conductive adhesive layer comprises one or more polymers and one or more electronic conductive fillers.

16. The method of claim 12, wherein the lithium foil further comprises:
an ionically conductive adhesive layer disposed between the lithium foil and the current collector, wherein the ionically conductive adhesive layer comprises one or more polymers, one or more electronic conductive fillers, and one or more ionic conductive fillers, and has an ionic conductivity greater than or equal to about 0.1 mS/cm to less than or equal to about 10 mS/cm.

17. The method of claim 12, wherein the lithium foil covers greater than or equal to about 20% to less than or equal to about 100% of a surface of the current collector, and wherein the lithium foil has a predetermined pattern.

18. The method of claim 17, wherein the surface of the current collector has sub-micro-scale surface roughening and a root mean square roughness greater than or equal to about 0.04 µm to less than or equal to about 2 µm.

19. The method of claim 12, wherein the current collector is a mesh current collector having a porosity greater than or equal to about 20% to less than or equal to about 80%.

20. A method of preparing an electrode to be used in an electrochemical cell that cycles lithium ions, the method comprising:
preparing a pre-lithiated, precursor electrode, wherein preparing the pre-lithiated precursor electrode comprises:
contacting a first electroactive material layer with a first surface of a lithium foil assembly; and
contacting a second electroactive material layer with a second surface of the lithium foil assembly to form the pre-lithiated, precursor electrode, wherein the first surface is parallel with the second surface, and the lithium foil assembly comprises:
a current collector,
a first lithium foil disposed on or adjacent to a first surface of the current collector, wherein the first lithium foil contacts the first electroactive material layer, and
a second lithium foil disposed on or adjacent to a second surface of the current collector, wherein the second lithium foil contacts the second electroactive material layer, wherein the lithium foil has a thickness greater than or equal to about 1 µm to less than or equal to about 200 µm; and
contacting the prelithiated, precursor electrode with an electrolyte in the electrochemical cell, wherein at least one of the first lithium foil and the second lithium foil at least partially or fully dissolves when contacted by the electrolyte to form the electrode and a lithium reservoir in the electrochemical cell.
